(19) United States
(12) Patent Application Publication
(10) Pub. No.: US 2017/0283631 A1
(43) Pub. Date: Oct. 5, 2017

(54) FAST CURING UV INKJET INKS BASED ON HYPER-BRANCHED POLYESTER ACRYLATES

(71) Applicant: HEIDELBERGER DRUCKMASCHINEN AG, HEIDELBERG (DE)

(72) Inventors: Thomas Paul, Heidelberg (DE); Jonas Philipp Presser, Otzeburg (DE); Sima Payandeh, Karlsruhe (DE); Mauela Hannelore Wolf, Kronberg/Taunus (DE); Silvia Worgt, Karlsruhe (DE); Jessica Gioia, Herxheim (DE)

(21) Appl. No.: 14/978,027

(22) Filed: Dec. 22, 2015

(30) Foreign Application Priority Data
Dec. 22, 2014 (DE) 102014018939.2

(51) Int. Cl. C09D 11/101; C09D 11/38; C08F 2/06; C09D 11/107; C08F 2/48; C09D 11/322; C09D 11/033

(52) U.S. Cl. CPC C09D 11/101; C09D 11/322; C09D 11/38; C09D 11/033; C09D 11/107; C08F 2/48; C08F 2/06

(57) ABSTRACT

A fast-curing UV inkjet ink is based on hyperbranched polyester acrylates. The ink contains the following components: 1 wt % to 20 wt % of at least one hyperbranched polyester acrylate having a functionality in the range from 6 to 30, 1 wt % to 30 wt % of at least one reactive diluent, 1 wt % to 20 wt % of at least one free-radical photoinitiator of the Norrish I type, 30 wt % to 70 wt % of at least one multifunctional (meth)acrylate monomer, and 0 wt % to 30 wt % of at least one monofunctional (meth)acrylate monomer. The ink is particularly suited for inkjet printing and it is used in an inkjet printing process.

### BACKGROUND OF THE INVENTION

### Field of the Invention

The present invention relates to a fast curing UV inkjet ink based on hyperbranched polyester acrylates. The present invention further relates to an inkjet printing process using the ink of the present invention.

Inks that are curable by way of UV radiation generally consist of monomeric and oligomeric materials, pigments, initiators and additives with or without a small amount of solvent.

Hyperbranched polymers having unsaturated end groups combine with suitable mono-, di- and polyfunctional acrylates into useful starting materials for systems such as UV crosslinkable paints, printing inks and coatings that usually have a comparatively high viscosity, see for instance J. A. Klang, Radiation-Curable Hyperbranched Polyester Acrylates, Paint and Coatings Industry, 2007. UV crosslinkable layers of this type are described, for example, in European published patent application EP 1 375 569 A1. In that document, hyperbranched polyester acrylates are used in UV curable layers.

Owing to their large number of terminal acrylate groups, hyperbranched polymers usable for UV crosslinking can be expected to show a high crosslinking rate and, because of their higher molecular weights versus available di- to hexafunctional acrylates, less shrinkage after crosslinking and hence potentially better adhesion to substrates. These properties are described, for example, in U.S. Pat. No. 7,365,105 B2. That document likewise discloses inks containing more than 30 wt % of acrylates having functionalities greater than 2, including inks containing up to 9 wt % of hyperbranched polyester acrylate.

Hyperbranched polyesters further have a lower viscosity than linear polyesters having similar structural elements and molecular weights, and therefore they are also useful as reactive diluents for high viscosity epoxy acrylates and linear polyester acrylates. Examples showing the viscosity reducing effect of hyperbranched polyesters having terminal acrylate groups are disclosed in International patent application WO 00/77070 A1 and in U.S. Pat. No. 6,828,411 B2 and its counterpart European published patent application EP 1 338 610 A1

United States patent application publication US 2011/0045199 A1 describes hyperbranched polyester acrylates in UV curable inks. Said inks contain hyperbranched polyester acrylates at from 10 wt % to 45 wt % and are stated to be fast curing, to have a low viscosity and to produce ink films that are flexible and highly adherent.

However, prior art inks still have appreciable disadvantages in that there are still no high performance inkjet printing inks that have a rapid rate of cure and good adherence to a broad spectrum of substrates and also exhibit good stability and good flexibility.

### SUMMARY OF THE INVENTION

It is accordingly an object of the invention to provide a UV curable ink which overcomes the above-mentioned and other disadvantages of the heretofore-known devices and methods of this general type and which provides for a UV curable ink based on hyperbranched polyester acrylates that has a low viscosity and is fast curing, has a low level of migration potential for the constituents, and is sufficiently curable at high printing speeds. The ink films should further be odor neutral and have a sufficient number of good properties, such as adhesion, mar resistance and solvent resistance.

With the foregoing and other objects in view there is provided, in accordance with the invention, a UV curable ink, comprising:

1-20 wt % of at least one hyperbranched polyester acrylate having a functionality in a range from 6 to 30;

1-30 wt % of at least one reactive diluent selected from the group consisting of ethylene glycol divinyl ether,diethylene glycol divinyl ether, triethylene glycol divinyl ether, propylene glycol divinyl ether, n-butanediol divinyl ether, 1,4-cyclohexanedimethanol divinyl ether, 1,4-cyclohexanedimethanol divinyl ether and mixtures thereof;

1-20 wt % of at least one free-radical photoinitiator of the Norrish I type;

30-70 wt % of at least one multifunctional (meth)acrylate monomer; and

0 wt % to 30 wt % of at least one monofunctional (meth)acrylate monomer.

The following are preferred ranges according to the invention:

The at least one hyperbranched polyester acrylate is present in a range between 5 wt % and 12 wt %, and its functionality lies in a range from 10 to 25, more preferably in the range from 12 to 20.

The at least one reactive diluent is present in a range from 5 wt % to 20 wt %.

The at least one free-radical photoinitiator of the Norrish I type is present in a range of 7 wt % to 17 wt %.

The at least one multifunctional (meth)acrylate monomer is present in a range from 35 wt % to 60 wt %.

The at least one monofunctional (meth)acrylate monomer is present in a range from 5 wt % to 15 wt %, alternatively preferably 0 wt % to 1 wt %.

The present inventors found that the inks defined above have a suitable viscosity for inkjet printing applications, cure rapidly and are sufficiently curable at high printing speeds. The constituents of the ink further have a low level of migration potential. The ink films further have a sufficient number of good properties such as adhesion, mar resistance and solvent resistance. A further advantage of the inks defined above is that they are substantially odor neutral by virtue of using hyperbranched polyester acrylates.

In the context of the present invention, the particulars in wt % are each based on the entire composition of the ink. “Comprising/containing at least” is to be understood in the context of the present invention as meaning that the ink contains at least one component, but optionally also two or more components and thus, for example, a mixture of 2, 3, 4, 5 6 or 7 components. A “mixture of two or more” is to be understood in the context of the present invention as meaning that the ink may contain two or more, i.e., for example 2, 3, 4, 5, 6 or 7, of the stated components. The term “UV” used in the present application for a patent is the abbreviation for ultraviolet radiation.

The ink of the present invention contains at least a hyperbranched polyester acrylate in an amount of 1 wt % to 20 wt %, preferably 5 wt % to 12 wt %, based on the entire composition of the ink. Hyperbranched polymers are designations for polymeric structures notable for a branched structure and a high functionality. The hyperbranched polyester acrylates, or polyester acrylate polymers, are both molecularly and structurally nonuniform and have branches that differ in length and the degree of branching. Suitable hyperbranched polyester acrylates are known to a person skilled in the art. They are for example commercially available under the brand names of Sartomer CN2300®, Sartomer CN2301®, Sartomer CN2302®, Sartomer CN2303®, Sartomer CN2304®, Sartomer CN2305®.

The hyperbranched polyester acrylates used generally have on average at least 6 functional groups and thus 6 acrylate groups as functional groups. There is in principle no upper limit to the number of functional groups. However, products having an excessive number of functional groups frequently have undesirable properties, for example poor solubility or a very high viscosity. Therefore, the hyperbranched polymers used for the purposes of the present invention generally have on average not more than 30 functional groups. The hyperbranched polymers preferably have 6 to 20 and more preferably 12 to 20 functional groups. The functionality of the hyperbranched polyester acrylates used is therefore in general in the range from 6 to 30, preferably in the range from 6 to 20, more preferably in the range from 12 to 20.

The ink of the present invention contains in general from 1 wt % to 20 wt % of at least one hyperbranched polyester acrylate having a functionality in the range from 6 to 30, from 30 wt % to 70 wt % of at least one multifunctional (meth)acrylate monomer and from 0 wt % to 30 wt % of at least one monofunctional (meth)acrylate monomer. This is because it was found in the context of the present invention that the conjoint use of these three components in the stated amounts delivers an ink that has a low viscosity and good curing rates. Inks of this type are very useful for inkjet printing and likewise deliver acceptable end user properties, such as adhesion, chemical resistance and good cure.

In a further preferred embodiment, the ink contains the at least one monofunctional (meth)acrylate monomer in an amount of 5 wt % to 15 wt %. In an alternative preferred embodiment, the ink of the present invention is free from monofunctional (meth)acrylate monomers, although minor amounts in the region of less than 1.0 wt % can be tolerated.

Multifunctional (meth)acrylate monomers for the purposes of the present invention are compounds where two or more acrylate groups are attached to one core molecule. In a preferred embodiment of the invention, the multifunctional (meth)acrylate monomer is selected from the group consisting of (meth)acrylic esters of alpha,omega-diols such as 1,4-butanediol dimethacrylate, 1,6-hexanediol diacrylate, 1,6-hexanediol dimethacrylate, 1,10-decanediol diacrylate, 1,10-decanediol dimethacrylate, 1,12-dodecanediol diacrylate, 1,12-dodecanediol dimethacrylate and also their ethoxylated and propoxylated derivatives such as ethoxylated 1,6-hexanediol diacrylate and propoxylated 1,6-hexanediol diacrylate, (meth)acrylic esters of ethylene glycol, propylene glycol and their oligomers and polymers such as 1,2-ethylene glycol diacrylate, 1,2-ethylene glycol dimethacrylate, diethylene glycol dimethacrylate, diethylene glycol diacrylate, triethylene glycol diacrylate, triethylene glycol dimethacrylate, tetraethylene glycol diacrylate, polyethylene glycol 200 diacrylate, polyethylene glycol 300 diacrylate, polyethylene glycol 400 diacrylate, propylene glycol diacrylate, propylene glycol dimethacrylate, dipropylene glycol diacrylate (Sartomer SR508®), tripropylene glycol diacrylate, tripropylene glycol triacrylate, 3-methyl-1,5-pentanediol diacrylate, neopentylglycol diacrylate, ethoxylated neopentylglycol diacrylate, propoxylated neopentylglycol diacrylate (Sartomer SR 9003®), trimethylolpropane triacrylate, trimethylolpropane trimethacrylate, ethoxylated and propoxylated trimethylolpropane triacrylate, ditrimethylolpropane tetraacrylate, glycerol propoxylate triacrylate, glycerol ethoxylate triacrylate, pentaerythritol triacrylate, pentaerythritol tetraacrylate, pentaerythritol tetramethacrylate, dipentaerythritol pentaacrylate, dipentaerythritol hexaacrylate (Rahn Miramer° M600), ethoxylated pentaerythritol tetraacrylate, tris(2-hydroxyethyl) isocyanurate triacrylate, ester diol diacrylate, tricyclodecanedimethanol diacrylate and the like and mixtures thereof.

In a more preferred embodiment of the invention, the multifunctional (meth)acrylate monomer is selected from the group consisting of 1,6-hexanediol diacrylate, 1,10-decanediol diacrylate, ethoxylated 1,6-hexanediol diacrylate, polyethylene glycol 200 diacrylate, dipropylene glycol diacrylate (Sartomer) SR508®, tripropylene glycol diacrylate, 3-methyl-1,5-pentanediol diacrylate, propoxylated neopentylglycol diacrylate (Sartomer SR 9003®), trimethylolpropane triacrylate, ethoxylated and propoxylated trimethylolpropane triacrylate, glycerol propoxylate triacrylate, glycerol ethoxylate triacrylate, pentaerythritol tetraacrylate, dipentaerythritol pentaacrylate, dipentaerythritol hexaacrylate (Rahn Miramer® M600), ethoxylated pentaerythritol tetraacrylate and mixtures thereof.

The at least one multifunctional (meth)acrylate monomer is generally present in the ink in an amount of 30 wt % to 70 wt %, preferably in an amount of 35 wt % to 60 wt %.

In a preferred embodiment of the invention, the monofunctional (meth)acrylate monomer is selected from the group consisting of butyl acrylate, octyl acrylate, octyl methacrylate, lauryl acrylate, lauryl methacrylate, isodecyl acrylate, isodecyl methacrylate, myristyl acrylate, decyl acrylate, stearyl acrylate, behenyl acrylate, isooctyl acrylate, isooctyl methacrylate, tridecyl acrylate, 2-propylheptyl acrylate, isobornyl acrylate, isobornyl methacrylate, tertiary-butylcyclohexyl acrylate, cyclohexanedimethanol diacrylate, caprolactone acrylate, 2-phenoxyethyl acrylate, 2-(2-ethoxyethoxy)ethyl acrylate, tetrahydrofurfuryl acrylate, ethoxylated phenoxyacrylate, 3,3,5-trimethylcyclohexanol acrylate, polycaprolactone acrylate, cyclic trimethylolpropane formal acrylate, ethoxylated 4-nonylphenyl acrylate, dihydrodicyclopentadienyl acrylate and the like, and mixtures thereof.

In a more preferred embodiment of the invention, the monofunctional (meth)acrylate monomer is selected from the group consisting of lauryl acrylate, isodecyl acrylate, myristyl acrylate, isobornyl acrylate, tertiary-butylcyclohexyl acrylate, 2-phenoxyethyl acrylate, 2-(2-ethoxyethoxy)ethyl acrylate, cyclic trimethylolpropane formal acrylate and the like and mixtures thereof.

In a particularly preferred embodiment, the ink of the present invention contains lauryl acrylate, myristyl acrylate and/or 2-phenoxyethyl acrylate as monofunctional (meth)acrylate monomer in an amount of 10 wt %.

The at least one monofunctional (meth)acrylate monomer is generally included in the ink in an amount of 0 wt % to 20 wt %, preferably in an amount of 5 wt % to 15 wt %, alternatively preferably in an amount of 0 to 1 wt %.

The ink of the present invention contains at least one reactive diluent in an amount of 1 wt % to 30 wt %, preferably 5 wt % to 20 wt %, based on the entire composition of the ink. The reactive diluent in a preferred embodiment of the invention is selected from the group consisting of vinyl containing monomers, in particular N-vinyl compounds such as N-vinylpyrrolidone, N-vinylcaprolactam, N-vinylformamide and vinyl ethers, such as ethyl vinyl ether, propyl vinyl ether, isopropyl vinyl ether, butyl vinyl ether, isobutyl vinyl ether, tert-butyl vinyl ether, amyl vinyl ether, 2-ethylhexyl vinyl ether, dodecyl vinyl ether, octadecyl vinyl ether, cyclohexyl vinyl ether, ethylene glycol monovinyl ether, ethylene glycol divinyl ether, diethylene glycol monovinyl ether, triethylene glycol monovinyl ether, tetraethylene glycol monovinyl ether, diethylene glycol divinyl ether, triethylene glycol divinyl ether, tetraethylene glycol divinyl ether, propylene glycol divinyl ether, polyethylene glycol divinyl ether, ethylene glycol butyl vinyl ether, triethylene glycol methyl vinyl ether, polyethylene glycol methyl vinyl ether, butanediol monovinyl ether, butanediol divinyl ether, hexanediol monovinyl ether, hexanediol divinyl ether, cyclohexanedimethanol monovinyl ether, cyclohexanedimethanol divinyl ether, trimethylolpropane trivinyl ether, aminopropyl vinyl ether, diethylaminoethyl vinyl ether and polytetrahydrofuran divinyl ether, vinyl esters, such as vinyl acetate, vinyl propionate, vinyl stearate and vinyl laurate, and vinylaromatics, such as vinyltoluene, styrene, 2-butylstyrene, 4-butylstyrene and 4-decylstyrene, 1,4-cyclohexanedimethanol divinyl ether and the like and mixtures thereof.

In a more preferred embodiment of the invention, the reactive diluent is selected from the group consisting of ethylene glycol divinyl ether, diethylene glycol divinyl ether, triethylene glycol divinyl ether, propylene glycol divinyl ether, 1,4-cyclohexanedimethanol divinyl ether, n-butanediol divinyl ether and mixtures thereof. In a particularly preferred embodiment, the reactive diluent is selected from the group consisting of diethylene glycol divinyl ether, triethylene glycol divinyl ether and n-butanediol divinyl ether, 1,4-cyclohexanedimethanol divinyl ether.

In a further preferred embodiment of the invention, N-vinylcaprolactam is not included in the ink of the present invention. Advantageously, the use of at least one reactive diluent selected from the group consisting of ethylene glycol divinyl ether, diethylene glycol divinyl ether, triethylene glycol divinyl ether, propylene glycol divinyl ether and n-butanediol divinyl ether and mixtures thereof, in particular the use of triethylene glycol divinyl ether as reactive diluent, provides an ink that health wise is appreciably less concerning than prior art inks containing N-vinylcaprolactam as reactive diluent.

In addition to the components described above, the ink of the present invention contains at least one free radical photoinitiator of the Norrish I type which on irradiation with ultraviolet light initiates the chain growth addition polymerization of thus polymerizable compounds present in the ink, such as the (meth)acrylate component(s) and the at least one divinyl ether. The initiators enlisted for the purposes of the present invention are specifically UV initiators which, in the usual chemical sense, enable, induce and/or hasten UV initiated reactions of other reactants, in particular the acrylates. According to the present invention, the enlisted initiators are those of the Norrish I type, which fragment into free radicals following an α-cleavage.

Examples of Norrish I type photoinitiators are 2-benzyl-2-dimethylamino-1-(4-morpholinophenyl)-butan-1-one (Irgacure® 369 and/or Genocure® BDMM), 2,4,6-trimethylbenzoyldiphenylphosphine oxide (Irgacure® TPO), 2-hydroxy-1-{4-[4-(2-hydroxy-2-methylpropionyl)benzyl]phenyl}-2-methylpropan-1-one (Irgacure® 127), 1-hydroxycyclohexyl phenyl ketone (Irgacure® 184, Doublecure® 184), phenylbis-2,4,6-trimethylbenzoylphosphine oxide (Irgacure® 819), 2-dimethylamino-2-(4-methylbenzyl)-1-(4-morpholin-4-ylphenyl)butan-1-one (Irgacure® 379), 2-hydroxy-2-methyl-1-phenylpropan-1-one (Darocur® 1173, Genocure® DHMA), 2-hydroxy-2-methylpropiophenone (Double Cure® 173), 2,2-dimethoxy-2-phenylacetophenone (Irgacure® 651), 2-methyl-1-[4-(methylothio)phenyl]-2-morpholinopropan-1-one (Irgacure® 907 and/or Genocure® PMP), 2,2-dimethoxy-1,2-diphenylethan-1-one (Genocure® BDK), methyl benzoylformate (Genocure® MBF), 2-hydroxy-4′-hydroxyethoxy-2-methylpropiophenone (Irgacure® 2959), 2-hydroxy-4′-methoxy-2-(4-methoxyphenyl)acetophenone, 2,2-diethoxyacetophenone and ethyl 2,4,6-trimethylbenzoylphenylphosphinate (Irgacure® TPO-L). [Please view the stated photoinitiators]

The Norrish I type photoinitiator is preferably selected from 2-benzyl-2-dimethylamino-1-(4-morpholinophenyl)butan-1-one (Irgacure® 369), 2,4,6-trimethylbenzoyldiphenyl-phosphine oxide (Irgacure® TPO), 2-hydroxy-1-{4-[4-(2-hydroxy-2-methylpropionyl)benzyl]phenyl}-2-methylpropan-1-one (Irgacure® 127), 1-hydroxycyclohexyl phenyl ketone (Irgacure® 184), phenylbis-2,4,6-trimethylbenzoylphosphine oxide (Irgacure® 819), 2-dimethylamino-2-(4-methylbenzyl)-1-(4-morpholin-4-ylphenyl)butan-1-one (Irgacure® 379). Methyl benzoylformate (Genocure® MBF), 2-hydroxy-4′-hydroxyethoxy-2-methylpropiophenone (Irgacure® 2959) and ethyl 2,4,6-trimethylbenzoyl-phenylphosphinate (Irgacure® TPO-L).

The photoinitiator is generally present in an amount of 1 wt % to 20 wt %, preferably in an amount of 7 wt % to 17 wt %, based on the entire ink of the present invention. In a preferred embodiment of the invention, the ink of the present invention does not contain any cationic photoinitiator.

The inks of the present invention may be, for example, inkjet printable clear varnishes. In this case, the inks are typically free from colorants and/or pigments.

In a preferred embodiment of the invention, the ink of the invention further contains at least one colorant. Dyes are possible colorants, but preference is given to pigments or a combination of pigments. It is possible to use organic and/or inorganic pigments that are commercially available in the form of pigment dispersions. A person skilled in the art is enabled by his or her general expertise to select a suitable colorant for the ink of the present invention.

Pigment particle size shall be less than 10 μm, preferably less than 3 μm and most preferably less than 1 μm. Mean pigment particle size is preferably between 0.05 and 0.5 μm.

The overall fraction of colorant present in the ink according to this embodiment of the invention is generally from 0.5 wt % to 15 wt %, preferably from 1 wt % to 15 wt %, based on the ink.

In one embodiment of the invention, the colorant is a pigment dispersion of 25 wt % of pigment in PONPGDA (RJA Dispersions D3420-O64), said colorant being included at from 10 wt % to 20 wt %, more preferably at 14 wt %, all based on the ink.

Other components of types known in the prior art may be present in the ink to improve its properties or performance. These components are known to a person skilled in the art and may be, for example, surface additives, such as BYK UV-3505, surfactants, defoamers, dispersants, synergists for the photoinitiator, stabilizers, such as BASF Irgastab® UV25, reodorants, flow or slip aids, biocides and identifying tracers. These further components are generally present in the ink of the present invention in an overall amount of about 0.25 wt % to 5 wt %.

The viscosity of the ink at a typical jetting temperature of 45° C. is generally in the range of 5 mPas to 25 mPas, preferably in the range from 5 mPas to 15 mPas, more preferably in the range from 7 mPas to 11 mPas. Printing temperatures are typically in the range from 30° C. to 60° C., preferably from 35° C. to 55° C.

The surface tension of the ink at 25° C. is generally in the range from 15 mN/m to 40 mN/m, preferably from 20 mN/m to 30 mN/m. The surface tension is not a given quantity, but is established through the addition of surface active substances.

The inks of the present invention are obtainable by known methods such as, for example, stirring with a high speed water cooled stirrer or grinding on a horizontal bead mill.

The ink of the present invention is preferably dried by ultraviolet irradiation and is suitable for application by inkjet printing. The present invention thus also provides a process for inkjet printing, which comprises using the ink described above.

### DETAILED DESCRIPTION OF AN EXEMPLARY EMBODIMENT

An embodiment of the invention will now be more particularly described by way of example:

An ink composition was prepared from the following constituents:
6 wt % of Irgacure® TPO (BASF SE)
6 wt % of Irgacure® 369 (BASF SE)
9 wt % of hyperbranched polyester acrylate (Sartomer CN2305)
10 wt % of lauryl acrylate (BASF LA1214)
10 wt % of triethylene glycol divinyl ether (BASF DVE-3)
42 wt % of DPGDA (Sartomer SR508®)
2 wt % of TMP(EO)3TA (Sartomer SR454®)
0.75 wt % of stabilizer (BASF Irgastab® UV25)
0.25 wt % of surface active substance (BYK UV-3505)
14 wt % of pigment dispersion (25% Pigment in PONPGDA; RJA Dispersions D3420-064)

The product was an ink having a viscosity of 10.6 m Pas at 45° C. The ink was printed onto plastics film/sheeting and paper labels and irradiated under light from an ultraviolet lamp of power 120 W/cm. The ink gave a print with good cure, adhesion and chemical resistance.

1. A UV curable ink, comprising:
1-20 wt % of at least one hyperbranched polyester acrylate having a functionality in a range from 6 to 30;
1-30 wt % of at least one reactive diluent selected from the group consisting of ethylene glycol divinyl ether, diethylene glycol divinyl ether, triethylene glycol divinyl ether, propylene glycol divinyl ether, n-butanediol divinyl ether, 1,4-cyclohexanedimethanol divinyl ether, 1,4-cyclohexanedimethanol divinyl ether and mixtures thereof;
1-20 wt % of at least one free-radical photoinitiator of the Norrish I type;
30-70 wt % of at least one multifunctional (meth)acrylate monomer; and
0 wt % to 30 wt % of at least one monofunctional (meth)acrylate monomer.

2. The ink according to claim 1, wherein the ink contains at least one hyper-branched polyester acrylate having a functionality in a range from 12 to 20.

3. The ink according to claim 1, wherein the reactive diluent is selected from the group consisting of N-vinylpyrrolidone, N-vinylcaprolactam, N-vinylformamide and vinyl ethers, such as ethyl vinyl ether, propyl vinyl ether, isopropyl vinyl ether, butyl vinyl ether, isobutyl vinyl ether, tert-butyl vinyl ether, amyl vinyl ether, 2-ethylhexyl vinyl ether, dodecyl vinyl ether, octadecyl vinyl ether, cyclohexyl vinyl ether, ethylene glycol monovinyl ether, ethylene glycol divinyl ether, diethylene glycol monovinyl ether, triethylene glycol monovinyl ether, tetraethylene glycol monovinyl ether, diethylene glycol divinyl ether, triethylene glycol divinyl ether, tetraethylene glycol divinyl ether, propylene glycol divinyl ether, polyethylene glycol divinyl ether, ethylene glycol butyl vinyl ether, triethylene glycol methyl vinyl ether, polyethylene glycol methyl vinyl ether, butanediol monovinyl ether, butanediol divinyl ether, hexanediol monovinyl ether, hexanediol divinyl ether, cyclohexanedimethanol monovinyl ether, cyclohexanedimethanol divinyl ether, trimethylolpropane trivinyl ether, aminopropyl vinyl ether, diethylaminoethyl vinyl ether and polytetrahydrofuran divinyl ether, vinyl esters, and vinylaromatics, 1,4-cyclohexanedimethanol divinyl ether and mixtures thereof.

4. The ink according to claim 3, wherein the vinyl esters are selected from the group consisting of vinyl acetate, vinyl propionate, vinyl stearate and vinyl laurate, and the vinylaromatics are selected from the group consisting of vinyltoluene, styrene, 2-butylstyrene, 4-butylstyrene and 4-decylstyrene.

5. The ink according to claim 1, wherein the multifunctional (meth)acrylate monomer is selected from the group consisting of pentaerythritol triacrylate, pentaerythritol tetraacrylate, pentaerythritol tetramethacrylate, dipentaerythritol hexaacrylate, 1,2-ethylene glycol diacrylate, 1,2-ethylene glycol dimethacrylate, diethylene glycol dimethacrylate, 1,4-butanediol dimethacrylate, triethylene glycol dimethacrylate, 1,6-hexanediol diacrylate, 1,6-hexanediol dimethacrylate, 1,12-dodecanol diacrylate, 1,12-dodecanol dimethacrylate, tris(2-hydroxyethyl) isocyanurate triacrylate, polyethylene glycol diacrylates and the acrylic esters of ethoxylated or propoxylated glycols and polyols, and mixtures thereof.

6. The ink according to claim 5, wherein the polyethylene glycol diacrylates are selected from the group consisting of tetraethylene glycol diacrylate, dipropylene glycol diacrylate, tripropylene glycol diacrylate, tripropylene glycol triacrylate, trimethylolpropane triacrylate, trimethylolpropane trimethacrylate, glycerol propoxylate triacrylate, dipentaerythritol pentaacrylate, ethoxylated pentaerythritol tetraacrylate, propoxylated neopentylglycol diacrylate, neopentylglycol diacrylate, and bis(pentaerythritol) hexaacrylate, and the acrylic esters of ethoxylated or propoxylated glycols and polyols are selected from the group consisting of propoxylated neopentylglycol diacrylate, ethoxylated or propoxylated trimethylolpropane triacrylate and mixtures thereof.

7. The ink according to claim 1, wherein the at least one monofunctional (meth)acrylate monomer is selected from the group consisting of lauryl acrylate, lauryl methacrylate, isodecyl acrylate, isodecyl methacrylate, myristyl acrylate, octadecyl acrylate, behenyl acrylate, cyclohexanedimethanol diacrylate, isobornyl acrylate, isobornyl methacrylate, caprolactone acrylate, 2-phenoxyethyl acrylate, isooctyl acrylate, isooctyl methacrylate, butyl acrylate and mixtures thereof.

8. The ink according to claim 1, comprising the at least one hyperbranched polyester acrylate having a functionality in the range from 6 to 30 in an amount of 5 wt % to 10 wt %, the at least one reactive diluent in an amount of 5 wt % to 20 wt % and the at least one multifunctional (meth)acrylate monomer in an amount of 35 wt % to 60 wt %.

9. The ink according to claim 1, wherein the at least one monofunctional (meth)acrylate monomer is present in an amount of 5 wt % to 15 wt %.

10. The ink according to claim 1, wherein the photoinitiator is selected from the group consisting of 2-benzyl-2-dimethylamino-1-(4-morpholino-phenyl)butan-1-one, 2,4,6-trimethylbenzoyldiphenylphosphine oxide, 2-hydroxy-1-{4-[4-(2-hydroxy-2-methylpropionyl)benzyl]phenyl}-2-methylpropan-1-one, 1-hydroxycyclohexyl phenyl ketone, phenylbis-2,4,6-trimethylbenzoylphosphine oxide, 2-dimethylamino-2-(4-methylbenzyl)-1-(4-morpholin-4-ylphenyl)butan-1-one, 2-hydroxy-2-methyl-1-phenylpropan-1-one, 2-hydroxy-2-methylpropriophenone, 2,2-dimethoxy-2-phenylacetophenone, 2-methyl-1-[4-(methylothio)phenyl]-2-morpholinopropan-1-one, 2,2-dimethoxy-1,2-diphenylethan-1-one, methyl benzoylformate, 2-hydroxy-4′-hydroxyethoxy-2-methylpropiophenone, 2-hydroxy-4′-methoxy-2-(4-methoxyphenyl)acetophenone, 2,2-diethoxyacetophenone and 2,4,6-ethyl trimethylbenzoylphenylphosphinate or a mixture of two or more.

11. The ink according to claim 1, wherein the photoinitiator is present in an amount of 7 wt % to 17 wt %.

12. The ink according to claim 1, which further comprises at least one colorant.

13. The ink according to claim 12, wherein the colorant is present in an amount of 0.5 wt % to 15 wt %.

14. The ink according to claim 1, wherein the ink has a viscosity at 45° C. in a range from 5 mPas to 25 mPas.

15. The ink according to claim 14, wherein the viscosity at 45° C. lies in a range from 5 mPas to 15 mPas.

16. The ink according to claim 1, wherein the ink has a surface tension of between 15 mN/m an 40 mN/m at 25° C.

17. A process for inkjet printing, which comprises providing the ink according to claim 1 and printing with the ink.
